(19) United States
(12) Patent Application Publication
(10) Pub. No.: US 2012/0120440 A1
(43) Pub. Date: May 17, 2012

(54) SCANNER MANAGEMENT APPARATUS, SCANNING SYSTEM, AND SCANNER MANAGEMENT METHOD

(76) Inventor: Saori UEDA, Kanagawa (JP)

(21) Appl. No.: 13/286,678

(22) Filed: Nov. 1, 2011

(30) Foreign Application Priority Data
Nov. 16, 2010 (JP) 2010-256060

(51) Int. Cl. G06F 3/12

(52) U.S. Cl. 358/1.15

(57) ABSTRACT

A scanner management apparatus to manage processing of image information scan-generated by one of multiple scanners connectable to a network includes a session establishment unit to establish a network session with one of the scanners in response to a session request from the scanner; a transmission support determination unit to determine whether a session-established scanner supports transmission of the scan-generated image information via the network; a driver checking unit to determine whether a driver matched to the session-established scanner is installed in the scanner management apparatus when the partner scanner does not support transmission of the scan-generated image information to the scanner management apparatus via the network; and a driver activation unit to activate the driver matched to the partner scanner to obtain the scan-generated image information generated by the partner scanner when the driver matched to the partner scanner is installed in the scanner management apparatus.

### CROSS-REFERENCE TO RELATED APPLICATIONS

This application claims priority to Japanese Patent Application No. 2010-256060, filed on Nov. 16, 2010 in the Japan Patent Office, which is incorporated by reference herein its entirety.

### BACKGROUND OF THE INVENTION

1. Field of the Invention

The present invention relates to a scanner management apparatus, a scanning system, and a scanner management program, and more particularly to an image capturing process employing a plurality of scanners via a network.

2. Description of the Background Art

With the advancement of information digitization, image processing apparatuses such as printers or facsimile machines for outputting digitized information and scanners for digitizing document information become indispensible apparatuses. Such image processing apparatuses have image capturing capability, image forming capability, and communication capability, which enables them to function as printers, facsimiles, scanners, copiers, or multi-functional apparatuses combining several of these capabilities and known as multi-functional peripherals (MFP).

When a plurality of scanners to digitize document information and a plurality of information processing terminals, which are typically personal computers (PC), are connected via a network, digitized document data can be shared by the plurality of multiple users, which is convenient.

In such scanners connected via the network, which may be called network scanners, scan settings can be input by operating a control/display panel of any one of network scanners, and a scan result can be transmitted to one or more user PCs via the network and stored in the user PCs to reduce the user burden such as physical back and forth movement of users between the user PCs and scanners. Such method is disclosed in, for example, JP-H09-51398-A.

Such network scanners have the ability to convert the scanned image data to a given format, such as joint photograph experts group (JPG) format or the like, and transmit the scanned data over the network. If a scanner having a data transmitting function is used, document scanning and data storage to a user PC can be completed when the user brings the document and operates the scanner for a scanning process.

In contrast, if a scanner not having a data transmitting function is used, a scan result or data cannot be stored in a user PC automatically. In such a case, a driver needs to be installed in the PC used for storing the scanned data, and after the driver installment, the scanned image data can be obtained from the scanner using the driver. As such, the scanner having the image data transmission function and the scanner not having the image data transmission function are operated differently to obtain the scanned image data from the scanner.

For example, as for the scanner having the image data transmission function, a scanning operation can be completed by setting parameters on a control/display panel of the scanner and executing a scanning process, in which the user can obtain image data automatically. In contrast, with the scanner not having the image data transmission function, a user needs to install a driver in his PC, and then the user brings the document to the scanner to conduct a scanning process. If the user brings the document to the scanner not having the image data transmission function and conducts a scanning operation without installing a driver matched to the scanner in his PC, he is unable to access the data and needs to install the driver in his PC used for storing the scanned image data after the scanning process.

As such, when various types of scanners are connected to a network in an office or the like, each of scanners may need different operations to obtain a scan result at users' PCs. However, general users not so knowledgeable about network systems may feel inconvenienced by such situation.

### SUMMARY

In one aspect of the present invention, a scanner management apparatus is devised. A scanner management apparatus to manage processing of image information scan-generated by any one of multiple scanners connectable to a network includes: a session establishment unit to establish a network session with any one of the scanners in response to a session request from the scanner via the network; a transmission support determination unit to determine whether a session-established scanner, used as a partner scanner of the scanner management apparatus, supports transmission of the scan-generated image information via the network; a driver checking unit to determine whether a driver matched to the partner scanner is installed in the scanner management apparatus when the partner scanner does not support transmission of the scan-generated image information to the scanner management apparatus via the network; and a driver activation unit to activate the driver matched to the partner scanner to obtain the scan-generated image information generated by the partner scanner when the driver matched to the partner scanner is installed in the scanner management apparatus.

In another one aspect of the present invention, a scanning system is devised. The scanning system includes a plurality of scanners connectable to a network, and a scanner management apparatus connectable to the plurality of scanners for managing processing of image information generated by a scanning process executed by any one of the scanners. Each scanner includes an application searching unit to search an information processing terminal used as the scanner management apparatus in which a given application is installed via the network in response to a user operation; and a session establishment unit to request and establish a session to the information processing terminal extracted by the searching of the application searching unit. The scanner management apparatus includes a session establishment unit to establish a network session with any one of the scanners in response to a session request from the scanner via the network; a transmission support determination unit to determine whether a session-established scanner, used as a partner scanner of the scanner management apparatus, supports transmission of the scan-generated image information to the scanner management apparatus via the network; a driver checking unit to determine whether a driver matched to the partner scanner is installed in the scanner management apparatus if the partner scanner does not support transmission of the scan-generated image information the scanner management apparatus via the network; and a driver activation unit to activate the driver matched to the partner scanner to obtain the scan-generated image information generated by the partner scanner when the driver matched to the partner scanner is installed in the scanner management apparatus.

In another one aspect of the present invention, a method of managing scanners and a scanner management apparatus connectable to each other via a network, the scanner management apparatus managing processing of image information generated by a scanning process executed by any one of the scanners, is devised. The method comprising the steps of a) establishing a network session between the scanner management apparatus and any one of the scanners in response to a session request from the scanner via the network; b) determining whether the session-established scanner, used as a partner apparatus, supports transmission of the scan-generated image information to the scanner management apparatus via the network; c) determining whether a driver matched to the partner scanner is installed in the scanner management apparatus when the partner scanner does not support transmission of the scan-generated image information to the scanner management apparatus via the network; and d) activating a driver when the driver matched to the partner scanner is installed in the scanner management apparatus to obtain the scan-generated image information generated by the partner scanner at the scanner management apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows an operation environment of an information management system according to an example embodiment;

FIG. 2 shows a block diagram of an example hardware configuration of an information processing terminal according to an example embodiment;

FIG. 3 shows a block diagram of an example functional configuration of a user terminal according to an example embodiment;

FIG. 4 shows an example of a scan setting screen according to an example embodiment;

FIG. 5 shows an example functional configuration of an image forming apparatus according to an example embodiment;

FIG. 6 shows a sequential chart of a scanning process by a scanning system according to an example embodiment;

FIG. 7 shows an example of a document set screen according to an example embodiment;

FIG. 8 shows a flowchart of steps of a determining process to determine whether a scanning is executable;

FIG. 9 shows a flowchart of steps of a determining process to determine whether an image transmission is executable;

FIG. 10 shows a sequential chart of a scanning process by a scanning system according to another example embodiment; and

FIG. 11 shows an example of document set screen according to another example embodiment.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, a scanning system, which can be used with a network, according to example embodiments is described hereinafter.

A description is given of a scanning system configured by connecting a plurality of scanners having different functions and a personal computer (PC) via a network, and the PC is installed with a scanner user interface (UI) application to manage the scanners connected to the network, in which a result of information processing such as scan result can be obtained with a similar manner for any one of the scanners by conducting a similar operation for any one of the scanners.

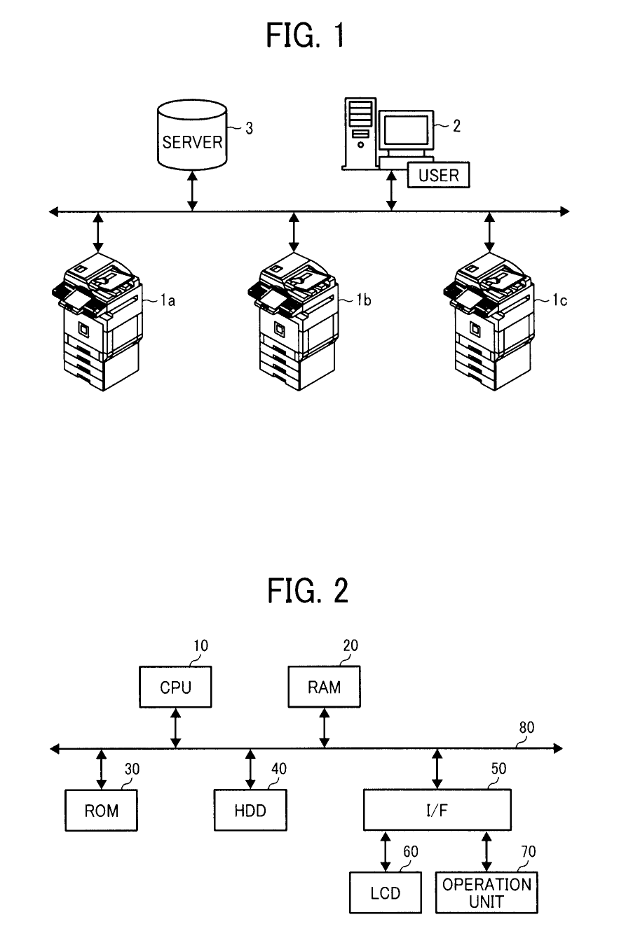

FIG. 1 shows an example of operation environment of a scanning system according to an example embodiment, wherein the scanning system is an example of an information management system. As shown in FIG. 1, the scanning system includes a plurality of image forming apparatuses 1a, 1b, 1c (hereinafter, image forming apparatus 1 collectively or as a single apparatus) having input/output functions such as printers and scanners, and a user terminal 2, which is an information processing terminal such as a personal computer (PC) operable by a user. The user terminal 2 can be used as an information management apparatus to manage scanners when the image forming apparatuses 1a, 1b, 1c are used as scanners, in which the user terminal 2 can be used as a scanner management apparatus.

The image forming apparatus 1 may include an image capturing function, an image forming function, and a communication function, by which the image forming apparatus 1 can be devised as a multi-functional apparatus useable as a printer, a facsimile machine, a scanner, and a copier. In an example embodiment, the image forming apparatuses 1a, 1b, and 1c have different functions. For example, when the image forming apparatuses 1a, 1b, and 1c function as scanners, some apparatuses have a function to transmit a scan result such as scanned data to the user terminal 2 and some apparatuses do not have a function to transmit a scan result such as scanned data to the user terminal 2. The user terminal 2 is an information processing terminal operable by a user, which is installed with a scanner user interface (UI) application according to an example embodiment.

A description is given of a hardware configuration of the image forming apparatus 1 and the user terminal 2 according to an example embodiment with reference to FIG. 2. FIG. 2 shows a block diagram of an example hardware configuration of the user terminal 2. The image forming apparatus 1 may have a hardware configuration similar to the user terminal 2.

As shown in FIG. 2, the user terminal 2 can be configured as similar to a general server or personal computer (PC). Specifically, the user terminal 2 includes a central processing unit (CPU) 10, a random access memory (RAM) 20, a read only memory (ROM) 30, a hard disk drive (HDD) 40, and an interface (I/F) 50 connectable to each other via a bus 80. Further, the I/F 50 is connectable to a liquid crystal display (LCD) 60 and an operation unit 70.

The CPU 10 is a computing processor or unit which controls the user terminal 2 as a whole. The CPU 10 can be configured with various types of processor, circuit, or the like such as a programmed processor, a circuit, an application specific integrated circuit (ASIC), used singly or in combination. The RAM 20 is a volatile memory, to which data or information can be written and read with a high speed, and is used as a working memory when the CPU 10 processes data or information. The ROM 30 is a non-volatile memory used as a read only memory, and stores programs such as firmware or the like. The HDD 40 is a non-volatile storage, to which data or information can be written and read, and stores operating system (OS), management or control programs, application programs, various data or the like.

The I/F 50 can be used to connect various types of hardware and network to the bus 80, and controls such connection. The LCD 60 is a user interface to display information visually, by which the status of the image processing apparatus 1 can be checked by a user visually. The operation unit 70 is a user interface such as a keyboard, a mouse, by which information can be input to the image processing apparatus 1 by the user. In case of the image forming apparatus 1, engines for scanner and printer are added to the hardware configuration shown in FIG. 2.

In such hardware configuration, programs stored in a storage area such as the ROM 30, the HDD 40, or an optical disk can be read and loaded to the RAM20, and the CPU 10 runs such programs to control various units, by which a software-executing controller can be configured. With a combination of such software-executing controller and hardware, a functional block to operate the image processing apparatus 1 and the client terminal 2 can be configured. In an example embodiment, at least one of the units is implemented in hardware or as a combination of hardware/software combination.

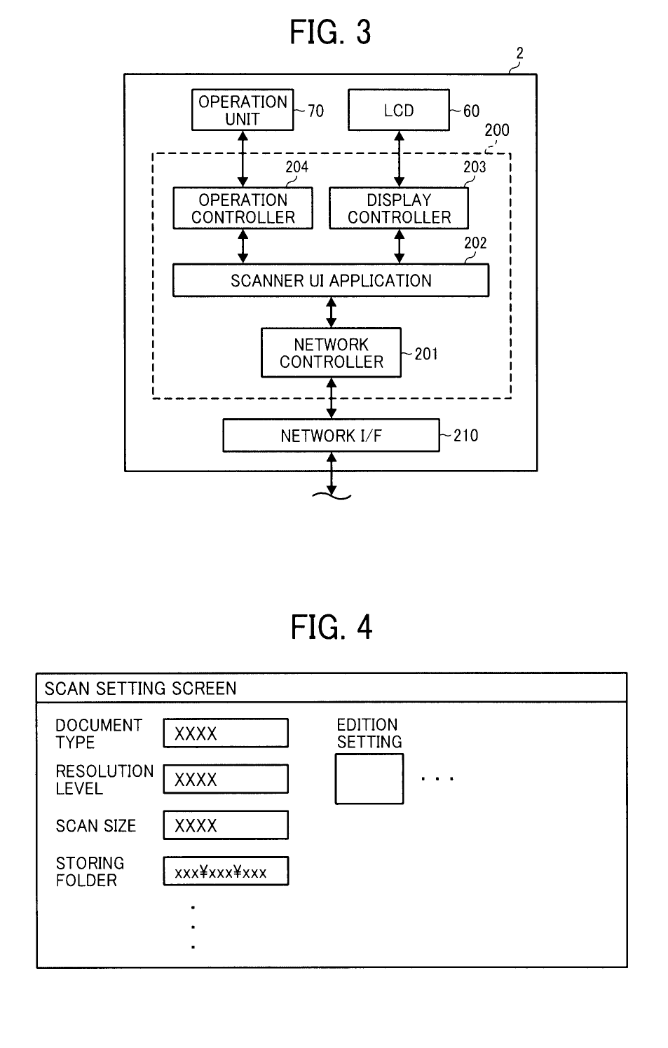

A description is given of a functional configuration of the user terminal 2 with reference to FIG. 3, which shows a block diagram of a functional configuration of the user terminal 2. As shown in FIG. 3, the user terminal 2 includes a controller 200 and a network I/F 210 in addition to the LCD 60 and the operation unit 70 shown in FIG. 2. The controller 200 includes a network controller 201, a scanner user interface (UI) application 202, a display controller 203, and an operation controller 204. The controller 200 can be configured with various types of processor, circuit, or the like such as a programmed processor, a circuit, an application specific integrated circuit (ASIC), used singly or in combination.

The user terminal 2 uses the network I/F 210 as an interface to communicate with other apparatuses via a network, and Ethernet (registered trademark), universal serial bus (USB) interface, or the like can be used for the network. The network I/F 210 can be as the I/F 50 shown in FIG. 2.

The controller 200 can function as a controller by a combination of software and hardware such as an integrated circuit. Specifically, a program stored in a non-volatile storage such as the ROM 30, a non-volatile memory, the HDD 40, and an optical disk is loaded to a volatile memory such as the RAM 20. The CPU 10 runs such program, by which a software-using controller is configured. The controller 200 controls the user terminal 2 as a whole to devise a process for the present invention. In an example embodiment, at least one of the units is implemented in hardware or as a combination of hardware/software combination.

The network controller 201 controls the network I/F 210 to conduct information transmission and reception via the network. The scanner UI application 202 according to an example embodiment can be configured by implementing an application program. Specifically, such application program is read from the RAM20, and the CPU 10 runs the application program to configure the scanner UI application 202.

The scanner UI application 202 includes various functions: a function to present a graphical user interface (GUI) useable for inputting scan setting information; a function of establishing a network session between the user terminal 2 and the image forming apparatus 1 used as a scanner; a function of reporting scan setting information, input via the GUI, to the image forming apparatus 1; and a function to determine whether the image forming apparatus 1 has a transmission function to transmit an image generated by a scanning process.

FIG. 4 shows a scan setting screen or graphical user interface (GUI) usable for inputting the scan setting information, wherein such screen or GUI can be provided by the scanner UI application 202. As shown in FIG. 4, the scan setting screen displays the scan setting information such as “document type,” “resolution level,” “scan size,” “storing folder,” “edition setting,” or the like. The scan setting information displayed on the scan setting screen is not limited to any specific conditions, but various types of scan setting information can be set as required.

A information processing apparatus such as PC installed with the scanner UI application 202 can be adapted to various types of scanners having various types of functions, and various types of scan settings can be set using the above described scan setting screen. Other functions of the scanner UI application 202 will be described later.

The operation controller 204 obtains information from the operation unit 70, which is input by a user's operation. The display controller 203 is used to display information on the LCD 60. Specifically, the display controller 203 obtains information for displaying the GUI (FIG. 4) from the scanner UI application 202, and then displays the GUI on the LCD 60 using the obtained information.

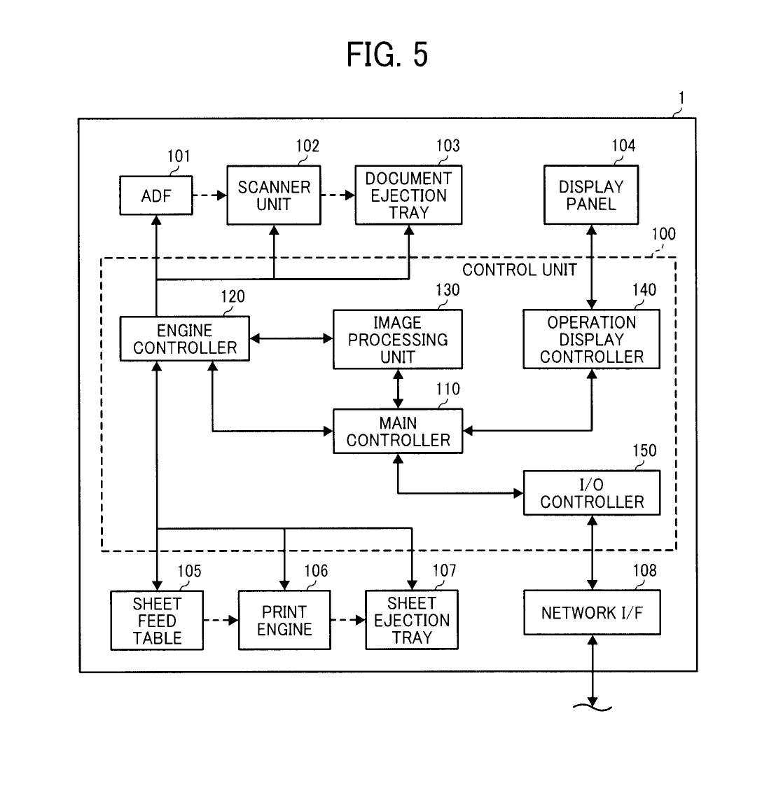

A description is now given of a functional configuration of the image processing apparatus 1 with reference to FIG. 5, which shows a block diagram of an example functional configuration of the image processing apparatus 1. As shown in FIG. 5, the image processing apparatus 1 may include, for example, a control unit 100, an automatic document feeder (ADF) 101, a scanner unit 102, a document ejection tray 103, a display panel 104, a sheet feed table 105, a print engine 106, a sheet ejection tray 107, and a network interface (I/F) 108.

Further, the control unit 100 may include, for example, a main controller 110, an engine controller 120, an image processing unit 130, an operation display controller 140, and an input/output (I/O) controller 150. As shown in FIG. 5, the image processing apparatus 1 may be configured as a multi-functional apparatus including the scanner unit 102 and the print engine 106, which may be known as the multi-functional peripherals (MFP). Further, the electrical connections are shown by a solid-line arrow, and the flow of recording sheet or document sheet is shown by a dotted-line arrow in FIG. 5.

The display panel 104 can be used as an output interface, which displays a status of the image processing apparatus 1 by using visual information, and also used as an input interface or operation unit to input information to the image processing apparatus 1 with an operation by a user. The display panel 104 may be devised as the LCD 60 and the operation unit 70 as shown in FIG. 2, and may be devised as a touch panel, for example, but not limited thereto.

The network I/F 108 is used as an interface for the image processing apparatus 1 when the image processing apparatus 1 communicates with other apparatus or devices such as the user terminal 2 or the like via the network. The network I/F 108 may be, for example, Ethernet (registered trademark), universal serial bus (USB) interface, or the like but not limited thereto. The network I/F 108 may be devised as the I/F 50 shown in FIG. 2. Further, the network I/F 108 may include a function of facsimile modem to function as an interface for facsimile transmission/reception when the image processing apparatus 1 conducts a facsimile transmission/reception via the network such as telephone lines.

The control unit 100 may be configured as a hardware or a combination of software and hardware. Specifically, one or more programs stored in a non-volatile memory such as the ROM 30, the HDD 40, and/or an optical disk can be loaded to a volatile memory such as the RAM20, and the CPU 10 conducts given processing using such programs, by which software-executing controller can be configured, and with a combination of software-executing controller and hardware such as an integrated circuit, the control unit 100 may be configured. The control unit 100 may function as a controller to control the image processing apparatus 1 as a whole. The control unit 100 can be configured with various types of processor, circuit, or the like such as a programmed processor, a circuit, an application specific integrated circuit (ASIC), used singly or in combination.

The main controller 110 controls each unit in the control unit 100 by transmitting instructions to the each unit. Further, the main controller 110 can conduct various processing in view of functionalities of the scanner UI application 202. Processing that can be conducted by the main controller 110 will be explained later. The engine controller 120 can be used as a driver to control and drive the print engine 106, the scanner unit 102, or the like.

The image processing unit 130 generates drawing-image information based on to-be-output image data under the control of the main controller 110. The drawing-image information is information used for image drawing when an image forming operation is conducted by the print engine 106, which is used as an image forming unit. Further, the image processing unit 130 processes data captured and input by the scanner unit 102 to generate image data. Such image data may be stored in a storage area of the image processing apparatus 1 as the data obtained by a scanning process, and can be transmitted to an external apparatus such as the user terminal 2, a server 3 such as a workflow server via the network I/F 108. The server 3 may or may not be disposed as required.

The operation display controller 140 displays various types of information on the display panel 104, and reports the various information input from the display panel 104 to the main controller 110. The input/output controller 150 inputs information, which is input via the network I/F 108, to the main controller 110. Further, the main controller 110 controls the input/output controller 150 to access the client terminal 2, the server 3, and other devices via the network I/F 108 and the network such as public communication line.

When the image processing apparatus 1 is operated as a printer, the input/output controller 150 receives a print job via the network I/F 108 at first. Then, the input/output controller 150 transfers the received print job to the main controller 110. When the main controller 110 receives the print job, the main controller 110 controls the image processing unit 130 to generate drawing-image information based on document information or image data included in the print job.

When the image processing unit 130 generates drawing-image information, the engine controller 120 controls the print engine 106 to conduct an image forming operation to a sheet, transported from the sheet feed table 105, based on the generated drawing-image information. Specific configuration of the print engine 106 may be, for example, an image forming mechanism using the inkjet method or an image forming mechanism using the electrophotography but not limited thereto. The sheet having received the image forming operation by using the print engine 106 may be ejected to the sheet ejection tray 107.

When the image processing apparatus 1 is operated as a scanner, the image processing apparatus 1 is input with a scanning execution instruction by a user's operation on the display panel 104, or input from an external device such as the user terminal 2 via the network I/F 108. In response to the input of scanning execution instruction, the operation display controller 140 or the input/output controller 150 transfers a scanning execution signal to the main controller 110. The main controller 110 controls the engine controller 120 based on the received scanning execution signal.

The engine controller 120 drives the ADF 101 to transport a document sheet having an image to be scanned to the scanner unit 102. Further, the engine controller 120 drives the scanner unit 102 to capture or scan the image of document transported from the ADF 101. When the document sheet is not set on the ADF 101 but is set directly in the scanner unit 102, the scanner unit 102 captures or scans image of document under the control of the engine controller 120. Accordingly, the scanner unit 102 can be operated as an image capturing unit or image scanning unit, and the engine controller 120 functions as a scan control unit.

When the scanner unit 102 conducts an image capturing operation, optically scanned document information can be captured by an image capturing device such as a charge-coupled device (CCD), and image data is generated based on the optically scanned document information. The engine controller 120 transfers the image data generated by the scanner unit 102 to the image processing unit 130. Under the control of the main controller 110, the image processing unit 130 generates image data based on the image data received from the engine controller 120. The image data generated by the image processing unit 130 may be stored in a storage area such as the HDD 40 in the image processing apparatus 1. As such, the scanner unit 102, the engine controller 120, and the image processing unit 130 may be interlinked to function as a document scanning unit.

The image data generated by the image processing unit 130 may be stored in the HDD 40 or the like, or transmitted to an external apparatus such as the user terminal 2 via the input/output controller 150 and the network I/F 108 in response to an instruction such as a user's instruction. In a case of the image forming apparatus 1 not having the image data transmission function to transmit a scan result such as scanned data, image information generated by the image processing unit 130 may be stored in a storage area in the image forming apparatus 1, and then a driver installed in the information processing terminal such as the user terminal 2 is activated to download the image information from the image forming apparatus 1 to the user terminal 2 via the network I/F 108.

Further, when the image processing apparatus 1 is operated as a copier, the image processing unit 130 generates drawing-image information based on the captured-image data received by the engine controller 120 from the scanner unit 102, or based on the image data generated by the image processing unit 130. As similar to the printing operation, the engine controller 120 drives the print engine 106 based on the drawing-image information. Further, if the drawing-image information and captured-image data use the same format, the captured-image data can be used as the drawing-image information as it is.

In an example embodiment, the scan function of multi-functional apparatus shown in FIG. 5 is used as a scanner. However, the scanner is not limited such type, but a scanning-only scanner can be used similarly for the scanning system according to an example embodiment.

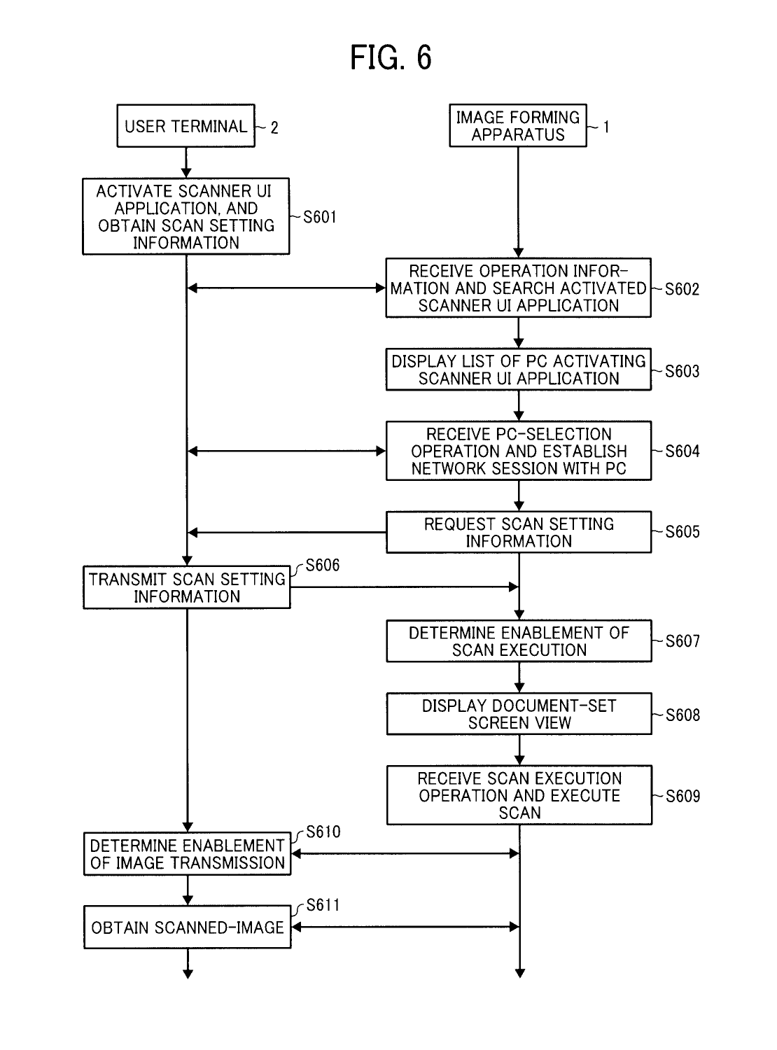

As for the scanning system according to an example embodiment, the image forming apparatus 1 having the image data transmission function of scan result and the image forming apparatus 1 not having the image data transmission function of scan result can be operated with a similar manner to obtain a similar result such as storing a scan result to the user terminal 2. A description is given of a scan processing of the scanning system according to an example embodiment with reference to FIG. 6, which shows a sequential chart of a scan processing of the scanning system.

As shown in FIG. 6, a user operates the user terminal 2 to activate the scanner UI application 202, and then the user terminal 2 obtains scan setting information, input via the scan setting screen shown in FIG. 4 (step S601). As such, the scanner UI application 202 functions as a setting screen information outputting unit. Then, the user brings a to-be-scanned document to the image forming apparatus 1, and operates the display panel 104 of the image forming apparatus 1.

In response to the user's operation activating the scanner UI application 202 at step S601, the main controller 110 of the image forming apparatus 1 searches the scanner UI application 202, which is being activated in the scanner system via a network (step S602). The main controller 110, which obtains an operation information input by the user's operation from the operation display controller 140, conducts step S602. As such, the main controller 110 can function as an application searching unit. Based on the search result at step S602, the scanner UI application 202 activated at step S601 can be extracted. Based on the extraction result, the main controller 110 generates a screen view to display a list of PC activating the scanner UI application 202, and instructs the operation display controller 140 to display the list of PC on the display panel 104 (step S603).

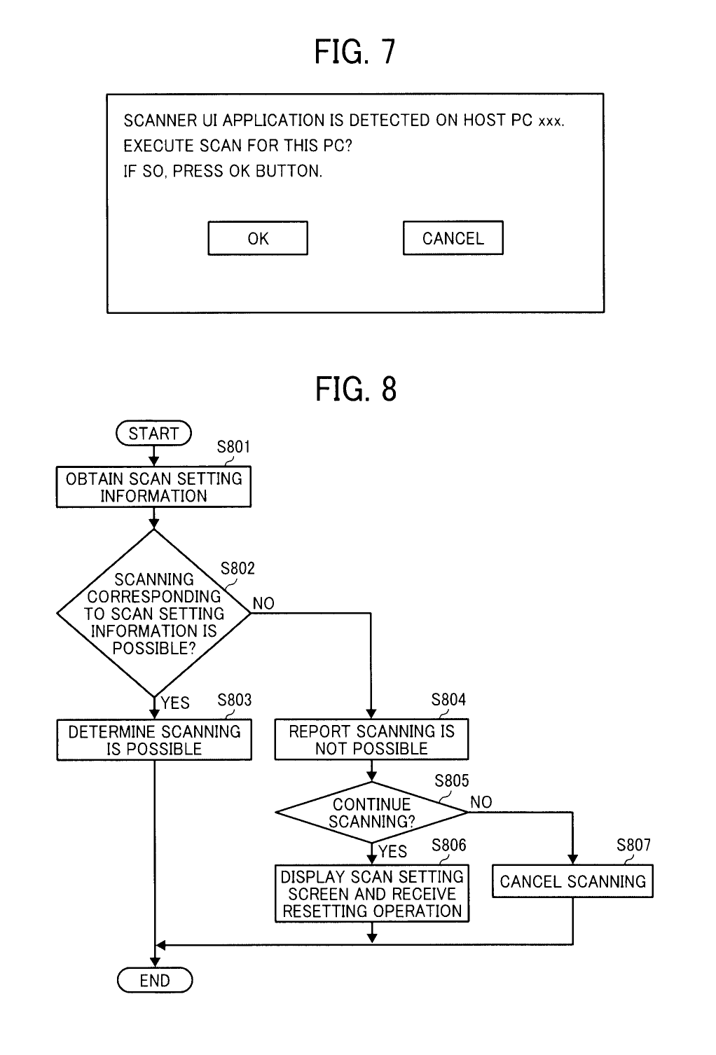

Then, the user operates a screen shown in FIG. 7 displayed on the display panel 104. Upon the user's operation on the screen (see FIG. 7), the main controller 110 of the image forming apparatus 1 receives a selection of PC selected via the operation display controller 140, and determines the PC to store the scan result in response to the user's operation, and establishes a network session with such PC (step S604). At step S604, the scanner UI application 202 of the user terminal 2 stores information of identifying the main controller 110 such as a network address of the main controller 110, and the main controller 110 stores information of identifying the scanner UI application 202 of the user terminal 2 such as a network address of the scanner UI application 202 of the user terminal 2. As such, the scanner UI application 202 and the main controller 110 stores identification information attached to a session counterpart. As such, each of the scanner UI application 202 and the main controller 110 functions as a session establishment unit.

Upon establishing a network session between the user terminal 2 and the image forming apparatus 1, the main controller 110 controls the I/O controller 150 to request the user terminal 2 to transmit the scan setting information, input at step S601 (step S605).

Upon receiving such transmission request of the scan setting information from the image forming apparatus 1, the scanner UI application 202 of the user terminal 2 transmits the scan setting information to the image forming apparatus 1 via the network controller 201 (step S606), wherein the scan setting information is input at step S601. As such, the scanner UI application 202 functions as a setting transmission unit. Further, instead of waiting such transmission request from the image forming apparatus 1, the scanner UI application 202 can transmit the scan setting information to the image forming apparatus 1 upon the session is established without a request from the image forming apparatus 1.

Upon receiving the scan setting information from the user terminal 2, the main controller 110 of the image forming apparatus 1 compares the content of received scan setting information and the scan function executable or capable by the image forming apparatus 1, and determines whether a scanning process of the content of scan setting information can be executable by the image forming apparatus 1 (step S607). As such, the main controller 110 functions as a scan execution determination unit. If the determination result of step S607 is that a scan execution is possible, the main controller 110 controls the operation display controller 140 to display a screen showing an instruction to set document and press a start button, by which the main controller 110 informs a start of scanning process using the scanner to the user (step S608).

Upon confirming the instruction shown on the screen at step S608, the user sets a document on the ADF 101 of the image forming apparatus 1 or a document tray of the scanner unit 102, and presses the start button to input the scan execution instruction displayed on the display panel 104. The main controller 110 of the image forming apparatus 1 receives the scan execution instruction via the operation display controller 140, and executes a scanning process by controlling each unit in the control unit 100 (step S609). /

At the user terminal 2, the scanner UI application 202 determines whether a scan result of the image forming apparatus 1 can be transmitted from the image forming apparatus 1 to the user terminal 2 via the network controller 201 (step S610). As such, the scanner UI application 202 functions as a transmission-support determination unit. The transmission support determination unit determines whether a session-established scanner, used as a partner scanner of the scanner management apparatus, supports transmission of the scan-generated image information to the scanner management apparatus via the network. The detail of step S610 will be described later. Then, the scanner UI application 202 obtains the scan result such as scanned image data from the image forming apparatus 1 by employing a method matched to the determination result determined at step S610, and stores the scanned image data in a storage such as the HDD 40 (step S611), and then the process ends.

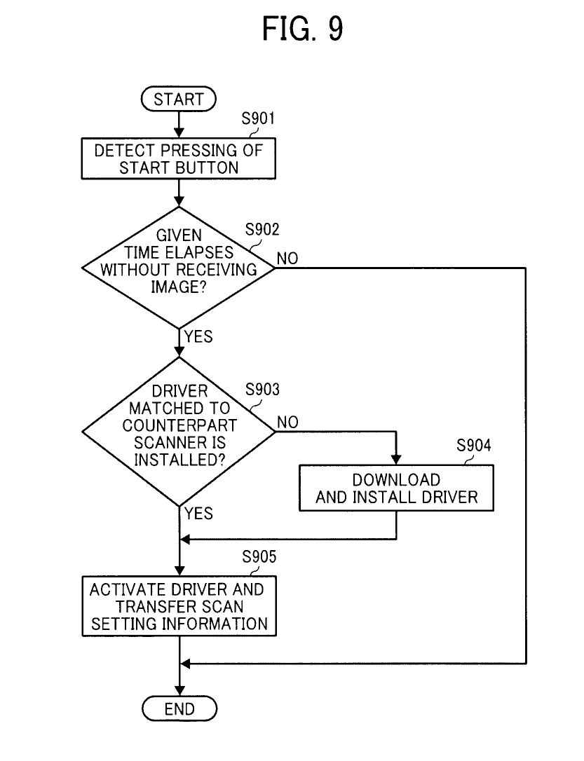

A description is given of step S607 of FIG. 6 with reference to FIG. 8. As shown in FIG. 8, the main controller 110 of the image forming apparatus 1 obtains the scan setting information transmitted from the user terminal 2 (step S801).

As above described, the main controller 110 functions as the scan execution determination unit, and determines whether a scanning process corresponding to the obtained scan setting information is executable by a scan function of the image forming apparatus 1 (step S802). At step S802, the determination is conducted based on, for example, the content of scan setting information shown in FIG. 4. For example, it is determined whether a scan function of the image forming apparatus 1 can execute a scanning process corresponding to the designated document type, designated resolution level, designated scan size, and/or designated edition setting.

Further, if a storing area of the user terminal 2 is designated as a “storing folder” at step S802, it is determined whether the image forming apparatus 1 has a function of transmitting a scan result to such storing folder. The detail of such process will be described later.

If the determination result at step S802 indicates the scanning process is possible (step S802: YES), the main controller 110 determines that the scanning process is possible (step S803), and ends the process of FIG. 8, and then proceeds to step S608 in FIG. 6.

In contrast, if the determination result at step S802 indicates the scanning process is not possible (step S802: NO), the main controller 110 reports the user that the scanning process is not possible (step S804). As such, the main controller 110 can function as a scan reporting unit to report that a scanning process is not possible.

At step S804, the reporting to user is displayed, for example, on the display panel 104. If the image forming apparatus 1 is not disposed with the display panel 104, the reporting to user can be conducted by flashing a light emitting diode (LED) or the like. Then, the main controller 110 waits a user's operation, and determines whether the scanning process is to be continued at the image forming apparatus 1 (step S805).

If the user inputs an instruction to continue the scanning process (step S805: YES), the main controller 110 controls the operation display controller 140 to display the scan setting screen on the display panel 104 of the image forming apparatus 1 (step S806). As such, the main controller 110 and the operation display controller 140 can function as a scanner setting screen processing unit. Then, through the setting screen on the display panel 104, the main controller 110 receives a resetting operation of scanning process via the operation display controller 140. With such a configuration, the user can continue the scanning process without going back to the user terminal 2 to set another scan setting information for the resetting operation.

In contrast, when the user inputs an instruction to stop a scanning process (step S805: NO), the main controller 110 cancels the process up to step S606 in FIG. 6 (step S807), and the process ends. With such a configuration, step S607 of FIG. 6 ends.

As such, if various types of scan setting information and/or values can be settable or selectable for any types of image forming apparatus 1 connected to the network using the scan setting screen (see FIG. 4) set by the scanner UI application 202, and by conducting the process shown in FIG. 8, the scanning system can be operated effectively and efficiently using any types of image forming apparatus 1 connected to the network.

A description is given of step S610 of FIG. 6 with reference to FIG. 9. The scanner UI application 202 has a function to detect a pressing of the start button used to input a scan execution instruction at the image forming apparatus 1 via the network, wherein the image forming apparatus 1 is already session-established with the scanner UI application 202 of the user terminal 2 at step S604 of FIG. 6. As such, the image forming apparatus 1 and the user terminal 2 can be used as partner apparatuses with each other. As shown in FIG. 9, the scanner UI application 202 detects the pressing of the start button at step S609 of FIG. 6 using such function (step S901).

If the image forming apparatus 1 has the transmission function of a scan result such as scanned image data (image data transmission function), the scan result can be transmitted to the user terminal 2 upon pressing the start button, which initiates subsequent processes of scanning processing and image processing to obtain the scanned image data.

In contrast, if the image forming apparatus 1 does not have the transmission function of a scan result such as scanned image data, the scan result is not transmitted to the user terminal 2 even if the start button is pressed. Specifically, if a given time elapses without receiving the scan result (step S902: YES) after detecting the pressing of the start button at step S901, the scanner UI application 202 determines that the image forming apparatus 1 has no image data transmission function, and the user terminal 2 starts to activate a given function to obtain image data from the image forming apparatus 1. Such determination and subsequent processes are devised in example embodiments. With such processing using a function of the scanner UI application 202, it can determine whether the image forming apparatus 1 has the image data transmission function without adding a process of reporting the transmission function availability of the image forming apparatus 1 from the image forming apparatus 1 to the user terminal 2. The transmission function availability means that the image forming apparatus 1 has or does not have the image data transmission function from the image forming apparatus 1.

If the given time elapses without receiving the scan result after detecting the pressing of the start button, the scanner UI application 202 checks whether a driver matched to the image forming apparatus 1, from which the image is obtained, is installed in the user terminal 2 (step S903). As such, the scanner UI application 202 functions as a driver checking unit. At step S903, drivers provided by makers of image forming apparatuses and/or general drivers for operating system (OS) may be checked.

If it is determined that the matched driver is already installed in the user terminal 2 (step S903: YES), the scanner UI application 202 activates the driver to use the content of scan setting information input at step S601 (FIG. 6) to the driver (step S905). Then, at step S611 (FIG. 6), the scan result such as scanned image data stored in a storing area of the image forming apparatus 1 can be downloaded and obtained by the user terminal 2 using the function of driver. As such, the scanner UI application 202 functions as a driver activation unit.

In contrast, if it is determined that the matched driver is not installed in the user terminal 2 (step S903: NO), the scanner UI application 202 downloads and installs a matched driver in the user terminal 2 (step S904). As such, the scanner UI application 202 functions as a driver download controller and the driver install controller. At step S904, the scanner UI application 202 can download a driver from the image forming apparatus 1 which is the session-established partner apparatus, or the server 3 connected via a public line such as the Internet. In such downloading process, the scanner UI application 202 obtains information of address that a driver is to be downloaded, wherein such address information may be uniform resource locator (URL) or the like transmitted from the image forming apparatus 1 (used as partner apparatus) or database pre-stored in the user terminal 2, but not limited thereto.

Upon completing the installment of driver, the scanner UI application 202 activates the driver, and transfers the content of scan setting information input at step S601 of FIG. 6 to the driver (step S905). With such a configuration, the scan result stored in a storing area of the image forming apparatus 1 can be downloaded and obtained by the user terminal 2 using the driver at step S611 of FIG. 6.

Further, if the scan result is received within the given time after detecting the pressing of the start button at step S901 (step S902: NO), the scanner UI application 202 ends the process. With such a configuration, the user terminal 2 can obtain image information transmitted from the image forming apparatus 1 at step S611 of FIG. 6. With such a configuration, the determination process to determine whether the image forming apparatus 1 has the image data transmission function can be completed.

As above described, as for the scanning system according to an example embodiment, the scanner UI application 202 is installed to a PC to store image data generated by the scanning process. Further, the scanner UI application 202 may include following functions: a function of setting various types of information; a function of session establishment with the image forming apparatus 1 used, for example, as a scanner; a function of transmitting scan setting information, selected and input by a user, to the image forming apparatus 1; a function of determining whether the image forming apparatus 1 has the image data transmission function; and a function of conducting a process based on the determination result whether the image forming apparatus 1 has the image data transmission function.

Further, the image forming apparatus 1 may include following functions: a function of searching a PC activating the scanner UI application 202 via a network; a function of establishing a network session with a PC activating the scanner UI application 202; a function of obtaining scan setting information from the scanner UI application 202; and a function of determining whether a scan using the obtained scan setting information is executable.

With such a configuration, even if a plurality of scanners having different functions and a user terminal are connected to each other via a network, a user can complete a scanning process using any types of scanners by conducting a similar operation for any types of scanners, and can store the scanned image data in his or her PC easily. Especially, when an image forming apparatus not having the image data transmission function is used, the scanner UI application 202 can automatically install and activate a driver, and thereby a user can complete a scanning process without considering or noticing by himself whether each one of image forming apparatuses has the image data transmission function.

Further, in the above described example embodiment, as explained with reference to FIG. 6, the scanner UI application 202 can provide the GUI shown in FIG. 4, and the scan setting information can be input using the GUI at the user terminal 2. With such a configuration, a user can input the scan setting information for any types of scanners using the same UI, in which the user does not need to operate different screens for different scanners.

Further, the scan setting information can be input by conducting a user's operation to the display panel 104 of the image forming apparatus 1, in which the scanner UI application 202 is used only for the session establishment with the image forming apparatus 1 and image transmission possibility determination at step S610. In such a case, the scanner UI application 202 does not display the GUI of FIG. 4 but can be operated using programs stored in a task tray or widget if Windows (registered trademark) OS or the like is used.

Further, in the above described example embodiment, as explained with reference to FIGS. 8 and 9, a determination whether a scan execution using the scan setting information such as “document type,” “resolution level,” and “scan size” is possible is conducted, and a determination whether the image forming apparatus 1 has an image data transmission function is conducted differently. Further, at step S802 of FIG. 8, it can be configured that the main controller 110 determines whether the image forming apparatus 1 has an image data transmission function to transmit a scan result.

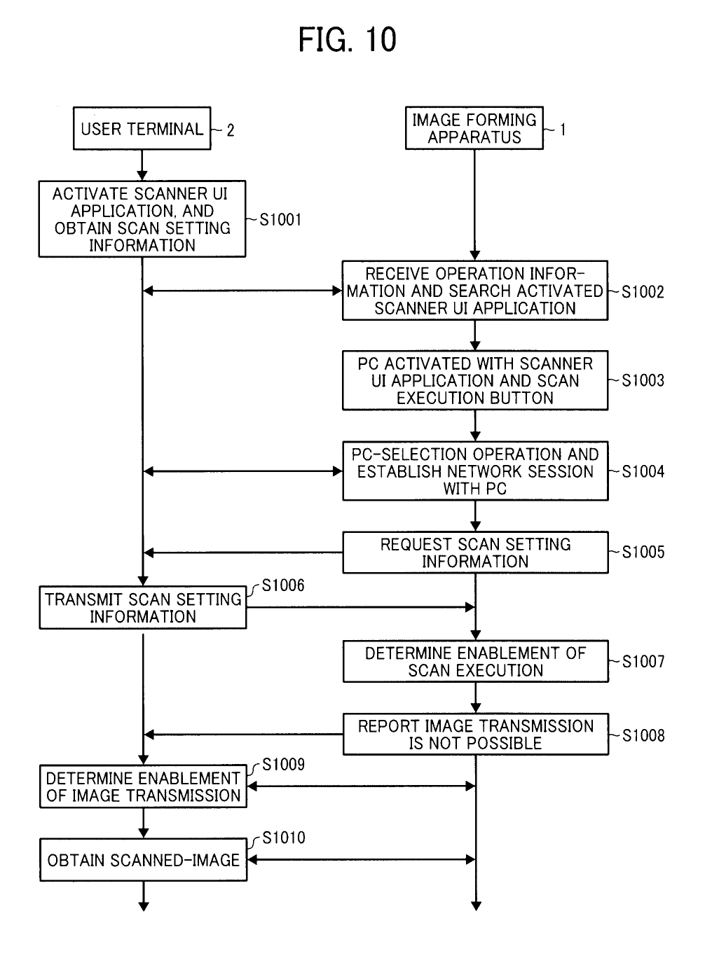

With reference to FIG. 10, a description is given of a system operation of the scanning system when the main controller 110 determines whether the image forming apparatus 1 has an image data transmission function. In FIG. 10, upon obtaining the scan setting information from the user terminal 2, it is determined whether the image forming apparatus 1 can execute a scanning process, and it is also determined whether the image forming apparatus 1 has the image data transmission function. The process of FIG. 10 shows a case when the image forming apparatus 1 not having the image data transmission function is used.

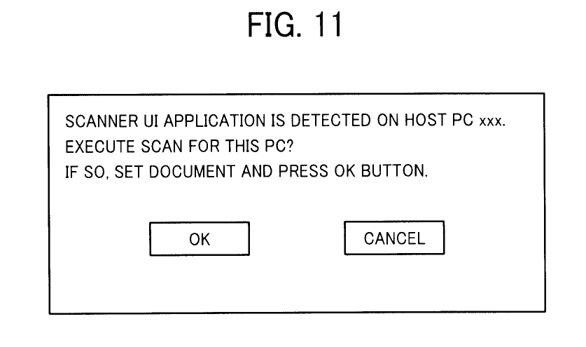

Steps S1001 and S1002 shown in FIG. 10 are same as steps S601 and S602 of FIG. 6. At step S1003, the image forming apparatus 1 displays a screen of FIG. 11 on the display panel 104 instead of the screen of FIG. 4. As such, at step S1003 in the process of FIG. 10, in addition to checking the session establishment, a screen for scan execution confirmation is displayed, which is displayed at step S608 of FIG. 6. Steps S1004 to S1006 shown in FIG. 10 are same as steps S604 to S606 of FIG. 6.

Upon obtaining the scan setting information from the user terminal 2, the main controller 110 of the image forming apparatus 1 determines whether the image forming apparatus 1 has an image data transmission function to transmit data to a storing area in the user terminal 2. Specifically, it is checked whether the image data can be transmitted to a storing folder, set as the scan setting information, when the storing area in the user terminal 2 is designated as the storing folder (step S1007). If the image forming apparatus 1 does not have the image data transmission function, the main controller 110 controls the I/O controller 150 to report that the image transmission is not possible to the user terminal 2 (step S1008).

Upon receiving the report from the image forming apparatus 1 at step S1008, the scanner UI application 202 of the user terminal 2 recognizes that the image forming apparatus 1 does not have a function of image data transmission function (step S1009). Then, the scanner UI application 202 of the user terminal 2 conducts steps similar to step S903 and subsequent steps of FIG. 9 to obtain image information (step S1010), and the process ends. Such example embodiment can obtain a similar effect of the previous example embodiment.

In an example embodiment corresponding to FIG. 10, the image forming apparatus 1 needs to have a determination function to determine whether the image forming apparatus 1 has an image data transmission function and a reporting function to report a determination result upon receiving the scan setting information from the user terminal 2. In an example embodiment corresponding to FIG. 6, the scanner UI application 202 installed in the user terminal 2 can conduct such functions, which is relatively easy to devise. Therefore, each of embodiments corresponding to FIGS. 6 and 10 needs to be selectively used in view of an apparatus environment or the like.

In step S806 of FIG. 8, the scan setting screen is displayed on the display panel 104 of the image forming apparatus 1. When an image forming apparatus I not disposed with the display panel 104 is used, a following configuration may be used.

For example, the main controller 110 can use a flashing of LED lamp or the like as a reporting unit to report an error status to a user, and outputs a flag signal for resetting the scanner via the I/O controller 150. At the user terminal 2, the scanner UI application 202 detects the flag signal via the network, and displays the GUI of FIG. 4 on the LCD 60 again via the display controller 203. In such a configuration, after confirming an error reported by the flashing of LED lamp, the user returns to his or her PC and confirms that the scan setting screen is displayed on the LCD 60, by which the user recognizes that the scan resetting is required. Further, a message that a scan execution corresponding to the input scan setting information is impossible can be added and displayed on the LCD 60. With such a configuration, even if a scanner not disposed of the display panel 104 is used, the effect similar to the above described example embodiments can be obtained except that the user needs to return to the user terminal 2.

Further, in the above described example embodiments, as described in FIG. 9, if a driver matched to a scanner is not installed in the user terminal 2 (step S903), a driver is automatically downloaded and installed. With such a configuration, a scanning process can be completed without notifying such downloading and installment of driver to the user. However, some users do not want such automatic installment of driver. In such a case, the installment of driver can be confirmed by the user.

For example, an installment of driver can be confirmed by the user as follows. If a driver matched to a scanner is not installed in the user terminal 2 (step S903), the scanner UI application 202 transmits an instruction for displaying a confirmation screen to the image forming apparatus 1 via the network controller 201, wherein the confirmation screen is used to determine whether a driver is to be installed or not. The display instruction of the confirmation screen is used as a signal to report that a driver matched to the image forming apparatus 1, used as a session partner scanner, is not installed. As such, the scanner UI application 202 can function as a driver-not-installed reporting unit.

At the image forming apparatus 1, the main controller 110 receives the display instruction of the confirmation screen via the I/O controller 150, and controls the operation display controller 140 to display the confirmation screen on the display panel 104. As such, the main controller 110 and the operation display controller 140 can function as a driver install confirmation screen display processing unit.

If the user approves an installment of the driver by operating the confirmation screen displayed on the display panel 104, the image forming apparatus 1 transmits a confirmation signal of the driver installment to the user terminal 2 via the network. Upon receiving the confirmation signal of the driver installment at the user terminal 2, the scanner UI application 202 obtains the confirmation signal and executes the process of step S904 of FIG. 9 to download and install the driver.

Further, if the image forming apparatus 1 not disposed of the display panel 104 is a session partner apparatus, the scanner UI application 202 displays the confirmation screen on the LCD 60 via the display controller 203, and can wait a user coming back to the user terminal 2.

As above described, even if scanners having different functions are used in a network environment, a scan result can be obtained from any one of the scanners similarly by conducting a similar operation for the scanners.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, work station) may control an information processing apparatus or an image processing apparatus such as image forming apparatus using a computer-readable program, which can execute the above-described processes or steps. Further, in the above-described exemplary embodiment, a storage device (or recording medium), which can store computer-readable program, may be a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, hard disk in a server, or the like, but not limited these. Further, a computer-readable program can be downloaded to a particular computer (e.g., personal computer) via a network such as the internet, or a computer-readable program can be installed to a particular computer from the above-mentioned storage device, by which the particular computer may be used for the system or apparatus according to an example embodiment, for example. In the above described embodiments, at least one or more of the units of apparatus can be implemented in hardware or as a combination of hardware/software combination.

Numerous additional modifications and variations are possibl1e in light of the above teachings. It is therefore to be undersltood that within the scope of the appended claims, the discl1osure of the present invention may be practiced otherwise than as s1pecifically described herein. For example, elements and/or fea1tures of different examples and illustrative embodiments may be co1mbined each other and/or substituted for each other within the s1cope of this disclosure and appended claims.

What is claimed is:

1. A scanner management apparatus to manage processing of image information scan-generated by any one of multiple scanners connectable to a network, comprising:
a session establishment unit to establish a network session with any one of the scanners in response to a session request from the scanner via the network;
a transmission support determination unit to determine whether a session-established scanner, used as a partner scanner of the scanner management apparatus, supports transmission of the scan-generated image information via the network;
a driver checking unit to determine whether a driver matched to the partner scanner is installed in the scanner management apparatus when the partner scanner does not support transmission of the scan-generated image information to the scanner management apparatus via the network; and
a driver activation unit to activate the driver matched to the partner scanner to obtain the scan-generated image information generated by the partner scanner when the driver matched to the partner scanner is installed in the scanner management apparatus.

2. The scanner management apparatus of claim 1, further comprising:
a driver download controller to obtain a network address, at which one or more drivers are stored, to download a driver matched to the partner scanner if the driver matched to the partner scanner is not installed in the scanner management apparatus; and
a driver install controller to install the downloaded driver, wherein the driver activation unit activates the installed driver to obtain the scan-generated image information generated by the partner scanner.

3. The scanner management apparatus of claim 2, wherein, after the transmission support determination unit detects an operation of a scan execution instruction at the scanner via the network and a given time elapses without receiving the scan-generated image information, the transmission support determination unit determines that the partner scanner does not support transmission of the scan-generated image information to the scanner management apparatus via the network.

4. The scanner management apparatus of claim 1, further comprising:
a setting screen information outputting unit to generate and output information used for displaying a setting screen through which a scan setting for the scanner is inputtable; and
a setting transmission unit to transmit the scan setting, input via the setting screen, to the session established partner scanner.

5. The scanner management apparatus of claim 4, wherein if a signal indicating that a scan cannot be executed using the transmitted scan setting at the session-established partner scanner is received via the network, the setting screen information outputting unit generates and outputs information used for displaying the setting screen again.

6. A scanning system, comprising:
a plurality of scanners connectable to a network; and
a scanner management apparatus connectable to the plurality of scanners for managing processing of image information generated by a scanning process executed by any one of the scanners,
wherein each scanner includes:
an application searching unit to search an information processing terminal used as the scanner management apparatus in which a given application is installed via the network in response to a user operation; and
a session establishment unit to request and establish a session to the information processing terminal extracted by the searching of the application searching unit,
wherein the scanner management apparatus includes:
a session establishment unit to establish a network session with any one of the scanners in response to a session request from the scanner via the network;
a transmission support determination unit to determine whether a session-established scanner, used as a partner scanner of the scanner management apparatus, supports transmission of the scan-generated image information to the scanner management apparatus via the network;
a driver checking unit to determine whether a driver matched to the partner scanner is installed in the scanner management apparatus if the partner scanner does not support transmission of the scan-generated image information the scanner management apparatus via the network; and
a driver activation unit to activate the driver matched to the partner scanner to obtain the scan-generated image information generated by the partner scanner when the driver matched to the partner scanner is installed in the scanner management apparatus.

7. The scanning system of claim 6, wherein the scanner management apparatus further includes:
a setting screen information outputting unit to generate and output information used for displaying a setting screen through which a scan setting for the scanner inputtable; and
a setting transmission unit to transmit the scan setting, input via the setting screen, to the session established partner scanner,
wherein the scanner further includes:
a scan execution determination unit to compare the scan setting received from the session-established scanner management apparatus and a scan capability of the scanner itself to determine whether the scanner can execute a scanning process using the received scan setting; and
a scan reporting unit to report that the scanner cannot execute the scanning process using the received scan setting if it is determined that scanner cannot execute the scanning process using the received scan setting.

8. The scanning system of claim 7, wherein the scanner further includes a scanner setting screen processing unit to display a setting screen on a display unit of the scanner useable to input a scan setting for the scanner if the scanning process using the received scan setting cannot be executed.

9. The scanning system of claim 7, wherein the scan reporting unit of the scanner also reports to the scanner management apparatus that the scanning process by the received scan setting is impossible to execute if the scanning process using the received scan setting is impossible to execute, and the setting screen information outputting unit of the scanner management apparatus generates and outputs information used for displaying the setting screen again when a report from the scan reporting unit is received.

10. The scanning system of claim 9, wherein the scanner management apparatus further includes a driver reporting unit to report that a driver matched to the partner scanner is not installed in the partner scanner, wherein the scanner further includes a driver install confirmation screen display processing unit to display a screen on the display unit of the scanner to confirm whether the driver is installable in the scanner management apparatus when a report is received from the scan reporting unit.

11. A method of managing scanners and a scanner management apparatus connectable to each other via a network, the scanner management apparatus managing processing of image information generated by a scanning process executed by any one of the scanners, the method comprising the steps of:
a) establishing a network session between the scanner management apparatus and any one of the scanners in response to a session request from the scanner via the network;
b) determining whether the session-established scanner, used as a partner apparatus, supports transmission of the scan-generated image information to the scanner management apparatus via the network;
c) determining whether a driver matched to the partner scanner is installed in the scanner management apparatus when the partner scanner does not support transmission of the scan-generated image information to the scanner management apparatus via the network; and
d) activating a driver when the driver matched to the partner scanner is installed in the scanner management apparatus to obtain the scan-generated image information generated by the partner scanner at the scanner management apparatus.
